(19) United States
(12) Patent Application Publication
(10) Pub. No.: US 2006/0011750 A1
(43) Pub. Date: Jan. 19, 2006

(54) Portable fire suppression apparatus

(76) Inventor: John P. Eldridge, Birchrunville, PA (US)

Correspondence Address: Laurence A. Weinberger;Suite 103, 882 South Matlack St., West Chester, PA, 19382, US

(21) Appl. No.: 10/889,872

(22) Filed: Jul. 13, 2004

(51) Int. Cl. B05B 15/00

(52) U.S. Cl. 239/547

(57) ABSTRACT

The present invention is a portable fire suppression apparatus. The fire suppression apparatus comprises a conduit with an open end and a closed end. In some embodiments of this invention the conduit may be a combination of several similar conduits connected with couplings with the last conduit having a closed end. The conduit has a plurality of apertures disposed upon its length at periodic intervals. When a fire suppression medium is forced throughout the conduit, the medium streams from each aperture and drenches the surrounding area and provides air borne spark suppression capability. In the preferred embodiment, this apparatus also includes a means for stabilizing the conduit against rotation while high pressure medium is forced through.

### BACKGROUND

1. Field of the Invention

This invention relates generally to fire suppression apparatus where rapid deployment over extended distances and uneven terrain is desired. Specifically, this invention relates to the use of portable conduits having a plurality of apertures along their lengths. Water forced through the conduit and out the apertures will wet the area along the length of the conduit. When sprayed upward, the water will tend to douse sparks carried by the wind. The conduit can be secured against rotation through the use of attached stabilizers. The invention is practiced in conjunction with a high pressure high volume water source such as a fire engine pump.

2. Description of Related Art

Every year fires, both natural and man made, cause numerous deaths as well as considerable amounts of property damage. Due to the overwhelming danger that these fires can present, techniques and apparatus have been developed to both assist professional fire fighters and to protect property.

Ence et al. in U.S. Pat. No. 4,330,040 teach the use of a piping system which is permanently fixed upon the roof of a structure. Ence et al. teach that the system cools and saturates a structure in such a manner so as to retard and prevent combustion of the structure in the face of an exterior fire. The system incorporates an exterior water source, such as a swimming pool, a pump and a series of delivery pipes having a plurality of apertures.

Orrange et al. in U.S. Pat. No. 6,360,968 teach the use of a semi permanent array of sprinkler legs situated on a structure's roof in conjunction with a water supply and a commercially available pumping mechanism. Orrange et al. teach that this array allows not only for the dwelling to be protected from a fire, but also wets the nearby ground and fauna and thus creates a buffer around the building which the fire can not easily leap. In addition, Orrange et al. teach that the array is capable of quick positioning upon a structure's roof in response to a forest fire.

Hall in U.S. Pat. No. 3,045,931 teaches the use of a spray nozzle attached to the terminal end of a length of hose which discharges water in the form of a curtain or shield around the immediate area of the terminal end of a length of hose. Hall teaches that the use of such a spray nozzle can protect fire fighters from the heat of a fire.

Schuler in U.S. Pat. No. 3,069,100 also teaches the use of a spray nozzle attached to the terminal end of a length of hose which creates a wall of water located at the terminal end of the length of hose. In addition, Schuler teaches the use of a stabilizing element for the spray nozzle. Schuler teaches that this stabilizing element allows for the spray nozzle apparatus to be self supporting and thus reduces the number of men required to stabilize and operate the spray nozzle. Schuler also teaches that the spray nozzle apparatus can effectively prevent the spread of a fire to nearby buildings, as well as effectively wet the floor or ground of the area within the vicinity of the terminal end of the length of hose.

Owens et al. in U.S. Pat No. 4,836,291 teach a self erecting portable sprinkler nozzle which can be attached to the terminal end of a flexible length of hosing. Owens et al. teach that when the terminal end of a length of hosing is attached to the sprinkler nozzle, and the length is then coiled around the sprinkler nozzle, the nozzle can be quickly deployed. Owens et al. teach that when high pressure water is passed through the coiled length of hosing the nozzle is forcibly and rapidly uncoiled outward like a party favor. Owens et al. teach that when the hose is fully extended the sprinkler nozzle creates a spray mist and water wall in the vicinity of the terminal end of the length of hose. Owens et al. teach that this allows fire fighters to safely and remotely fight fires which would normally be unapproachable, such as petrochemical blazes.

Choitz in U.S. Pat. No. 3,033,470 teaches the use of a plurality of nozzles interposed between sections of hosing, the final section of hosing possessing a cap on its terminal end. The nozzles are utilized in an intermittent series between sections of hosing so as to form a substantially continuous water curtain along the length of the hosing. Choitz teaches that this substantially continuous water curtain can be used to protect fire fighters as well as structures in a fire's path.

Heller et al. in U.S. Pat No. 3,738,429 teach the use of a fire suppression system for use in the interior of a structure. The system incorporates a: 1) stationary conduit, which when pressurized supplies fire extinguishing medium; and 2) a length of folded hose attached by foil strips to the conduit which, when deployed by pressurization, hangs downwardly towards the floor of a warehouse. The length of hose has spray openings through which the fire extinguishing medium can pass, and the unattached end of the hose is closed with blind couplings. The hose normally rests in a folded state directly beneath the pipe and unfolds in the presence of a fire.

### BRIEF SUMMARY OF THE INVENTION

The present invention comprises conduits capable of containing high water pressures and having apertures disposed along their length at varying or periodic intervals. The apertures may incorporate nozzles. The conduits also incorporate a means for coupling with additional conduits and with a high pressure high volume water source. Several conduits may be coupled together to form a combined continuous length. The end of the conduit (or joined conduits) furthest away from the water source is closed. When the conduit is used in conjunction with a high pressure high volume water source, such as a fire engine pump, water sprays under pressure from the apertures drenching all low lying areas within the spray's range and also acts to douse sparks driven by wind across the wetted area. In embodiments of this invention in which the conduit comprises a flexible length of hose, the length of hose may be stored coiled about a large roll. This permits the hose to be rapidly moved and deployed to combat an approaching fire. In embodiments of this invention in which the conduit comprises a length of rigid or semi-rigid pipe, several pipes may be conveniently stacked for rapid deployment and connection. Variations in water pressure, pumped flow volume, and aperture size allow for an increased effective length of the conduit over which an adequate volume of water may be delivered.

The conduit preferably incorporates a stabilizing means to prevent rotation about a longitudinal axis.

### BRIEF DESCRIPTION OF THE FIGURES

FIG. 1 is a perspective side view of the conduit of this invention with upwardly directed streams of water depicted in broken lines.

FIG. 2 is a perspective top view of the conduit with a median line drawn for reference.

FIG. 3 is a perspective top view showing multiple conduit sections coupled together.

FIG. 4 is a perspective side view showing a flat stabilizer attached to the bottom of the conduit of the invention.

FIG. 5A is a cross sectional view of an alternative stabilizing bracket for use with the conduit of this invention.

FIG. 5B is a cross sectional view of another alternative stabilizing bracket for use with the conduit of this invention.

FIG. 6 is a perspective top view showing two attached conduits fastened together side by side.

FIG. 7A is a cross sectional side view of two conduits attached with an attachment means encircling both conduits.

FIG. 7B is a cross sectional side view of two conduits attached with a detachable attachment means.

FIG. 8 shows the conduit implemented as a flexible hose partially extended from a roll.

### DETAILED DESCRIPTION OF THE INVENTION

Outdoor fires often spread rapidly across large areas especially when a strong wind accompanies the fire. Standard techniques for halting or slowing the spread of the fire often involve the creation of a fire break basically consisting of an area where no combustion can occur. Generally, fire breaks consist of extended areas, perhaps thousands of feet long, in front of the advancing fire. Due to the time required to create the breaks, they are usually placed well ahead of the anticipated direction the fire will take. The fire breaks are typically created by the deliberate stripping of combustible vegetation from the area by bulldozers, by the soaking of the vegetation with water, or by creating backfires along the projected path of the fire. Physical removal of the combustible vegetation is most often used since it is difficult to deploy and supply water pumping apparatus over the extended lengths used to create the fire breaks. Water soaking of an area is generally limited to those situations where a structure is located which it is desired to save from the fire.

The present invention provides an apparatus which permits a water spray soaking fire break to be created over extended distances without the necessity of deploying pumping apparatus and their required water sources over the length of the break. The spray provides a soaked area to retard the advance of fire and a wet barrier to douse wind driven sparks and debris. The apparatus of the invention is easily portable and may be deployed relatively quickly and over uneven terrain. Such portability and ease of deployment permits a break to be created nearer the fire front thereby exposing less land to the possible ravages of the fire than can be accomplished where the break must be located further away to allow time for construction. The apparatus of the invention may also be used in conjunction with a fire break created by the stripping of vegetation to enhance the effectiveness of the break in stopping the spread of the fire. The apparatus of the invention may also be used to partially or totally surround buildings to prevent fire from spreading to the buildings. In appropriate circumstances, the apparatus of the invention may be deployed indoors to directly fight or retard interior fires. For purposes of this patent disclosure, the term “high pressure” refers to pressures which are in excess of those typically provided by water mains or household water supplies. Typically, for instance, fire engine pumps may supply water at a pressure up to 600 pounds per square inch.

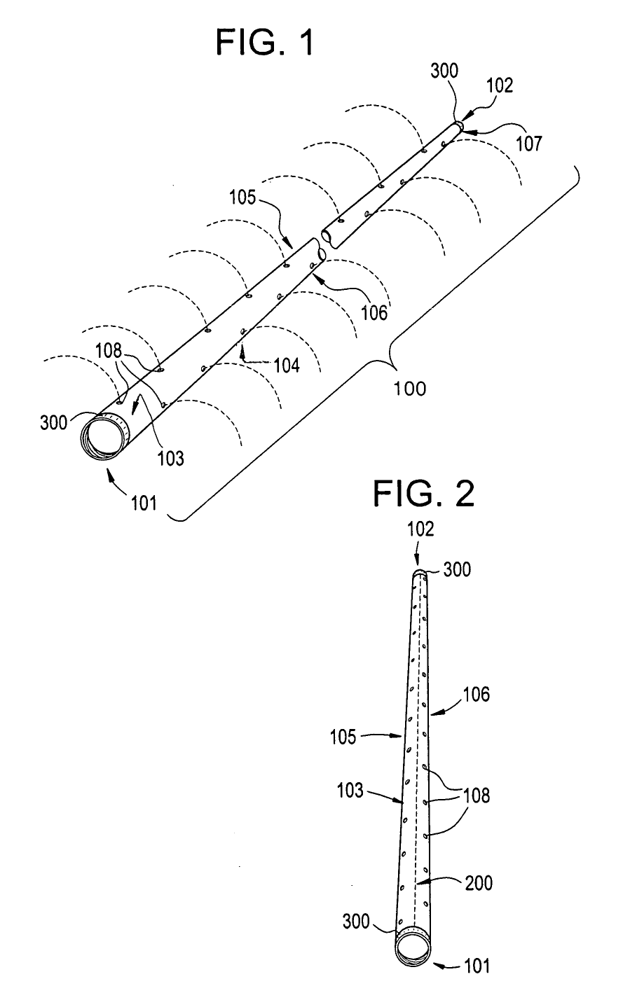

FIG. 1 shows a cylindrical conduit 100 with a first end 101 and a second end 102. While the conduit is circular, for purposes of reference in this disclosure, a top portion 103, a bottom portion 104, a left side portion 105, and a right side portion 106 are defined. A plurality of apertures 108 are disposed along the length of the conduit. At each end 101 and 102 a coupling unit 300 is located which permits either the attachment of the conduit to a water source, to additional lengths of conduits, or permits attachment of a cap at the end furthest from the water source. In the preferred embodiment of the invention, the coupling units 300 at each end of the conduit 100 comprise fittings of a standard type designed to couple with the high pressure output of fire engine pumps.

Materials used in the manufacturing of fire hoses may be used in the construction of flexible conduits for this invention. Some examples of such hose materials include, but are not limited to single jacket hoses, double jacket hoses, nitrile coated hoses, pin rack hoses, covered fire hoses, hard suction hoses as well as booster fire hoses. Materials typically used in the manufacture of pipes may be used in construction of the conduits of this invention provided the wall thickness and/or material is sufficient to withstand the high pressures employed. In addition, the material from which the pipe is formed should be sufficiently light weight so that the pipe sections can be easily handled and deployed. Generally, plastic materials well known in the art can be employed in the manufacture of the pipes for the apparatus of the invention.

As can readily be appreciated, high pressure water input at one end of the conduit 101, which is capped at the opposite end 102, will be forced out the apertures 108 along the conduit's length.

In FIG. 2 a perspective top view of the conduit 100 is pictured. For the purposes of defining aperture placement only, FIG. 2 shows a median line 200 on the top side 103 lying equidistant between the left side 105 and the right side 106. Apertures 108 may be placed along only one side of the conduit (to one side of the median line) or may be located on both sides of the conduit (on both sides of the median line). In the preferred embodiment, apertures 108 are placed on both sides of the conduit and lay within 45 degrees of median line 200. This placement allows for a maximum range of water spray from the apertures. Alternatively, apertures 108 may be placed along the median line 200.

In the preferred embodiment, conduits 100 are formed from flexible high pressure hose. In such conduits, the edges of the apertures may be reinforced by means well known in the art so that the force of water flowing through the apertures does not damage the flexible hose material. Many such hoses are manufactured in-side out and then inverted. This permits easy access for the reinforcement to be mounted. In an alternative embodiment in which the conduits are formed from piping, the apertures may also be reinforced.

In the simplest embodiments of the invention, the apertures comprise small round holes. However, apertures may be formed with nozzles of types well known in the art. Such nozzles may produce, for example, a single directed water stream or a wider water spray.

When a conduit is connected to a high pressure high volume water pump, water will be forced along the length of the conduit until it encounters the capped end. At this point, pressure will build up within the conduit and be forced out of the apertures along its entire length. The effective length of the conduit is the length over which sufficient water is discharged through the apertures to effectively soak the vegetation around the conduit to create a saturated area resistant to the spread of fire. Additionally, the water spray acts to prevent fire spreading by wind driven sparks and embers. Several factors contribute to the effective length. Primary factors are: 1) the pressure and volume input to the conduit; 2) the diameter of the conduit; and 3) the size of the apertures. The total surface area of the apertures effectively constitutes the outlet diameter for calculating, by methods well known in the art, the size of the pump which is required to deliver sufficient volume through each aperture. Where a longer effective length is desired, apertures with a smaller diameter may be employed. Where a shorter effective length is desired, larger apertures may be employed. The effective length may also be increased by using fewer apertures. Apertures designed to accommodate aperture plugs may be used to vary the number of open apertures along the length of the conduit to alter the effective length to that required in a particular circumstance. The apertures 108 may be uniformly/periodically distributed along the length of the conduit, or in particular circumstances may have other distribution patterns. For instance, in a long hose no apertures may be located near the high pressure water source so that the water spray does not start until some distance from the high pressure water source.

Ideally, the pressure at the aperture farthest from the pump should be sufficient to provide a desired water flow at that aperture. The diameter of the conduit is crucial to maintaining the water pressure throughout the length of the conduit. A significant pressure drop for each 100 feet is encountered with smaller diameter conduits. (For instance, the NFPA lists the pressure drop per unit length for hoses of different diameters.) Accordingly, the present invention is best practiced with larger diameter conduits and, most preferably, with diameters of at least 4 inches.

The slope of the terrain over which the conduit is deployed will also influence the effective length. Where the terminal (capped) end is significantly higher than the pump, a pressure drop will occur as a consequence of the need for the pump to force the water uphill. Conversely, when the terminal end is lower than the pump, there will be a pressure increase. In circumstances well understood in the fire protection art, pressure regulators may need to be placed between adjacent conduit sections on a downhill run to prevent the pressure from exceeding the burst pressure of the conduit. Additionally, on an uphill run booster pumps may be employed between conduit sections when the pressure would otherwise decrease below a desirable threshold level.

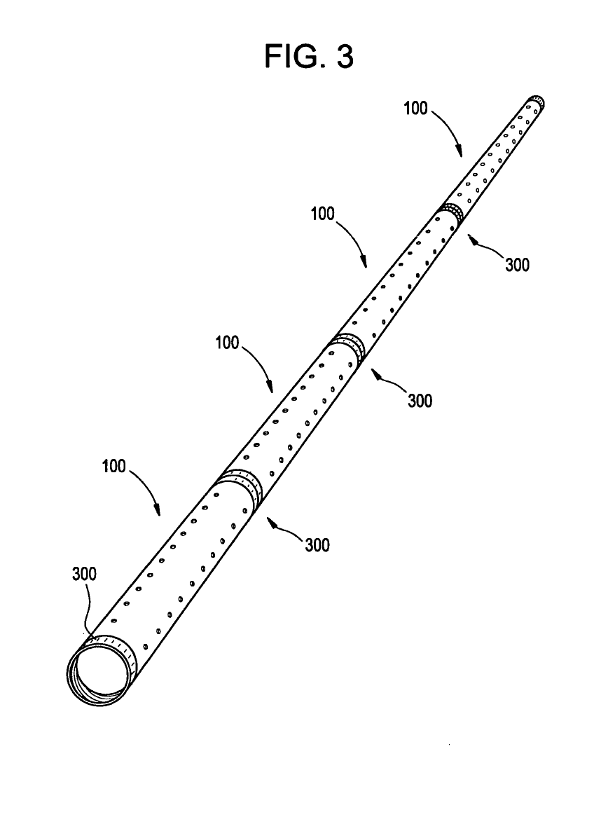

In FIG. 3 a side perspective view shows lengths of conduit 100 connected together in series via couplings 300. The use of multiple lengths of conduit as opposed to a single continuous length permits the selection of an appropriate length for the fire break it is desired to establish. In addition, it is generally desirable to keep the pumping source (such as a fire engine) safely removed from the fire. In certain circumstances, the water source may also be located at some distance from the position where it is desired to establish a fire break. The present invention allows the use of sections of conduits (such as standard fire hoses), which do not have apertures, to be connected to the pump and then, at some distance away from the pump, to be connected to the apertured conduits of this invention. Multiple conduits may also be assembled in configurations such as switchbacks which allow for coverage of a large area rather than an elongated traditional fire break.

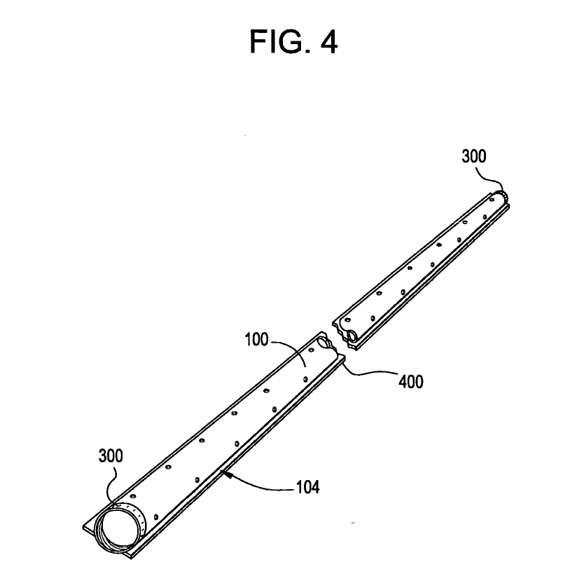

It can be appreciated that a substantially round conduit described above will be susceptible to rotation about its centerline when deployed. Such rotation would direct the water streams from the apertures in undesired directions such as, for example, directly into the ground. To prevent rotation, one of several means to stabilize the conduit may be employed. In FIG. 4, one such stabilizer is shown. A substantially flat support 400, which preferably extends beyond the sides of the conduit 100, is fixedly attached to the bottom 104 of the conduit. Preferably the support 400 is substantially resistant to flexing along its width but may flex along its length.

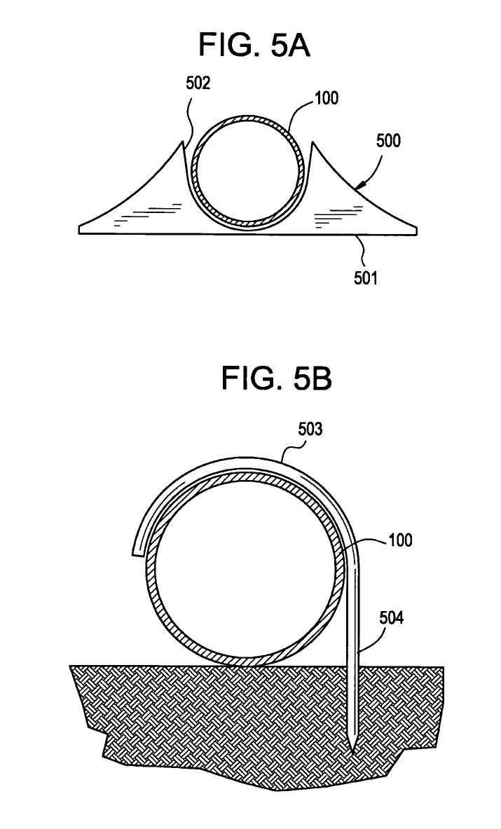

An alternative stabilizer is shown in cross section in FIG. 5A. Here the stabilizer consists of a bracket 500 having a bottom 501 and a receiving means 502 into which the conduit 100 is placed. An alternative stabilizing bracket shown in FIG. 5B has a receiving means 503 fixedly connected to a peg 504 which may be hammered into the ground to fix the conduit in place to prevent rotation.

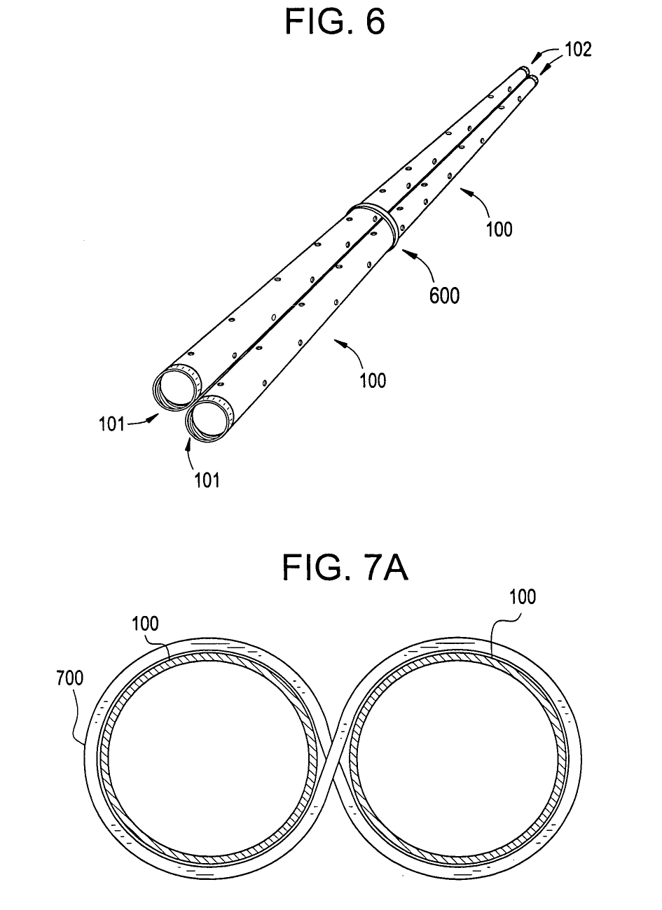

An alternative method of stabilization, which also may be used to double the amount of water delivered for each length, is shown in FIG. 6. As shown diagrammatically, two conduits 100 are fastened together side by side with fastener 600. The fastening of the two conduits allows for added stability against rotation since each is prevented from rotating by the weight of the other. Fastening may be accomplished by any of the means well known in the art including but not limited to brackets, adhesives, or weaving.

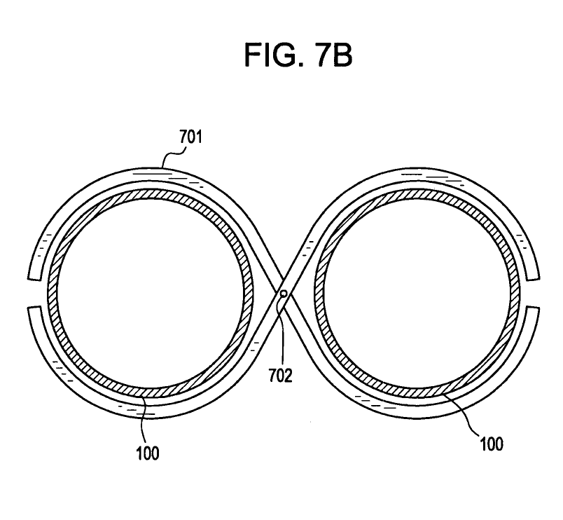

FIG. 7A shows a cross sectional view of a two conduits 100 fastened together by fastener 700. The fastener 700 employed is in the form of a metal or plastic band fastened around the exterior of the two conduits (not shown) or preferably fastened in a figure eight (as shown) about the exterior of the two fastened conduits.

FIG. 7B shows a cross sectional view of two conduits fastened together by removable fastener 701. Fastener 701 may be constructed from plastic or metal and is in the shape of a figure eight with the left and right side open so as to allow rotation about a hinge pin 702 located at the central axis of the figure eight.

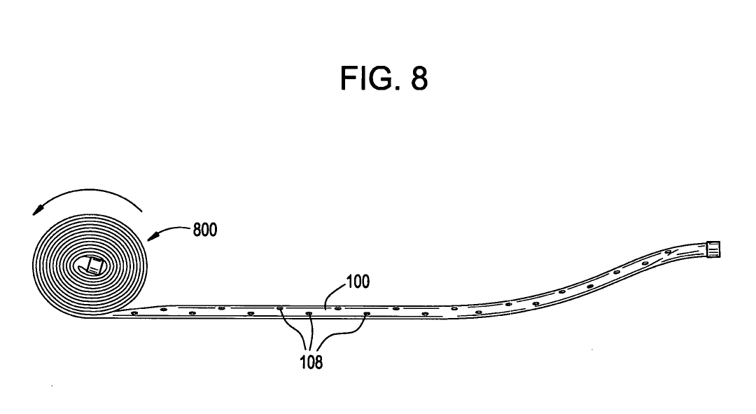

The apparatus of this invention is used by placing and connecting lengths of conduit 100 along the length of the desired fire break. As shown in FIG. 8, a flexible version of the conduit of this invention, such as flexible hose, may be stored in rolls 800 which are transported to the location of the desired break. The hose may then be rapidly deployed by unwinding the rolls. Lengths of hose from several such rolls may be connected to obtain the desired length keeping in mind the effect the terrain will have on the pressure. The stabilizing bracket shown in FIG. 4 may be rolled up with the hose and simultaneously deployed with the hose. A twin or double hose as shown in FIG. 6 may also be rolled up and deployed. Alternatively, the brackets shown in FIGS. 5A and 5B may be fastened to the single hose at intervals as the hose is unwound from the roll. Brackets shown in FIGS. 7A and 7B may be used to fasten two hoses as the hoses are unwound. Since conduits comprised of hoses are relatively flexible even when pressurized, the hoses can conform to uneven terrain which may be encountered. Finally, if desired, a standard non-apertured hose may be used to connect the hose of the apparatus of this invention to a high pressure high volume water pump. It should be noted that while fire trucks are routinely used, any high volume high pressure water pump may be used with the apparatus of this invention. Examples of water sources for the pump include, but are not limited to fire hydrants, water tanks, or swimming pools. The use of a rolled hose also permits a rapid repositioning of the fire break in response to changes in fire direction by merely rerolling the hose and unrolling the hose at the new desired position.

When conduits which comprise pipes are used, stacks of pipes may be transported to the desired site, removed from the transporter, and connected. A flexible connector (such as a length of flexible hose—not shown) may be used between pipe sections to permit the piping to conform to uneven terrain. The pipe may be connected directly to the high pressure high volume water pump but is preferably connected to the pump with flexible hose. Again, non-apertured conduit (such as pipe or hose) of suitable diameter may be used to transfer water some distance from the pump to the apertured piping of this invention. In appropriate circumstances, brackets as shown in FIGS. 5A and 5B may also be used with piping.

In appropriate circumstances, fire suppression materials other than water may be used with the apparatus of this invention.

It is understood that the present invention is not limited to the particular description set forth above but comprises any modification within the scope of the appended claims.

I claim:

1. A portable fire suppression apparatus utilizing a high pressure source comprising:
a) a conduit having a first and second end;
b) means for coupling located at the first end and second ends of the conduit;
c) means for sealing the conduit located at a second end of the conduit; and
d) a plurality of apertures located along the length of the conduit
wherein the first end of the conduit may be coupled to a high pressure source.

2. The apparatus of claims 1 wherein the conduit is comprised of hose.

3. The apparatus of claims 1 wherein the conduit is comprised of pipe.

4. The apparatus of claims 1 further comprising a means to prevent rotation of the conduit about a longitudinal axis.

5. The apparatus of claim 4 wherein the means to prevent rotation of the conduit about a longitudinal axis comprises a means to fasten two conduits together side by side.

6. A portable fire suppression apparatus utilizing a high pressure source comprising:
a) a conduit having a first and second end;
b) means for coupling located at the first and second ends of the conduit;
c) a plurality of apertures located along the length of the conduit; and
d) an end cap
wherein the first end of the conduit is coupled to a high pressure source and the other end of the conduit is coupled to the end cap.

7. The apparatus of claim 6 wherein the conduit is comprised of hose.

8. The apparatus of claim 6 wherein the conduit is comprised of pipe.

9. The apparatus of claim 6 further comprising a means to prevent rotation of the conduit about a longitudinal axis.

10. The apparatus of claim 9 wherein the means to prevent rotation of the conduit about a longitudinal axis comprises a means to fasten two conduits together side by side.

11. A portable fire suppression apparatus utilizing a high pressure source comprising:
a) two or more conduits with ends;
b) means for coupling the conduits located at the ends of each conduits;
c) a plurality of apertures located along the length of the conduits; and
d) an end cap
wherein two or more conduits are coupled together and one end of the coupled conduits is connected to a high pressure source and the other end of the coupled conduits is coupled to an end cap.

12. The apparatus of claim 11 wherein the conduit is comprised of hose.

13. The apparatus of claim 11 wherein the conduit is comprised of pipe.

14. The apparatus of claim 11 further comprising a means to prevent rotation of the conduit about a longitudinal axis.

15. The apparatus of claim 14 wherein the means to prevent rotation of the conduit about a longitudinal axis comprises a means to fasten two conduits together side by side.
